(19) United States
(12) Patent Application Publication
(10) Pub. No.: US 2014/0340669 A1
(43) Pub. Date: Nov. 20, 2014

(54) Unknown

(71) Applicant: Carl Zeiss Sports Optics GmbH, Wetzlar (DE)

(72) Inventors: Hans-Juergen Dobschal, Kleinromstedt (DE); Armin Schlierbach, Leun-Bissenberg (DE); Christian Sinn, Giessen (DE)

(73) Assignee: Carl Zeiss Sports Optics GmbH, Wetzlar (DE)

(21) Appl. No.: 14/260,398

(22) Filed: Apr. 24, 2014

Related U.S. Application Data
(60) Provisional application No. 61/816,963, filed on Apr. 29, 2013.

(30) Foreign Application Priority Data
Apr. 29, 2013 (DE) 102013207852.8

(51) Int. Cl. G01S 17/08; G01S 7/481; G01S 7/51; G02B 5/18; G02B 5/32

(52) U.S. Cl. CPC G01S 17/08; G02B 5/18; G02B 5/32; G01S 7/51; G01S 7/481
USPC 356/4.01; 356/3

(57) ABSTRACT

A long-range optical instrument comprises at least one observation beam path and an apparatus for laser ranging comprising at least one transmission apparatus with a transmission beam path and at least one reception apparatus with a reception beam path, moreover comprising an image rendering unit. The transmission beam path of the transmission apparatus and/or the reception beam path of the reception apparatus are combined using at least one optical support element for superposition with the at least one observation beam path. The image rendering unit generates the light of an image to be superposed and likewise guides said light using the at least one optical support element for superposition with the at least one observation beam path. Moreover, for beam shaping and/or beam guidance, at least one diffractive optical coupling element is arranged at the optical support element in the transmission beam path and/or in the reception beam path.

The invention relates to a long-range optical instrument comprising at least one observation beam path and comprising an apparatus for laser ranging, in accordance with the preamble of claim 1.

Known optical observation instruments with separate laser ranging optical units already have compact housings in order to accommodate the corresponding additional beam paths. The optical systems are adapted to the instrument geometry by using diffractive optical elements which require little installation space, for example diffraction gratings.

Document DE 10 2007 007 380 B4 describes binocular field glasses with a folding bridge, two observation beam paths and means for laser ranging. For the purposes of laser ranging, there is a transmission apparatus with a transmission beam path and a reception apparatus with a reception beam path, which are both arranged outside of the two observation beam paths. Here, the transmission apparatus and the reception apparatus are each housed in separate housing parts of the field glasses, separately from the two observation beam paths. The transmission apparatus and reception apparatus are arranged in the region of a central axis of the folding bridge and, as a result thereof, are movable relative to one another. There is at least one diffractive optical element for beam shaping purposes.

Furthermore, document DE 10 2008 059 892 A1 has disclosed a device for superimposing an image into the beam path of a sighting optical unit. To this end, an optical support element, at least partly transmissive to light, comprising a diffractive optical coupling-in element and decoupling element, is arranged in the beam path of the sighting optical unit.

It is an object of the invention to develop a long-range optical instrument in terms of the compactness and performance thereof.

According to the invention, this object is achieved by the features specified in claim 1. The further dependent claims relate to advantageous embodiments and developments of the invention.

The invention includes a long-range optical instrument, comprising at least one observation beam path and comprising an apparatus for laser ranging comprising at least one transmission apparatus with a transmission beam path and at least one reception apparatus with a reception beam path, moreover comprising an image rendering unit. The transmission beam path of the transmission apparatus and/or the reception beam path of the reception apparatus are combined by means of at least one optical support element for superposition with the at least one observation beam path. The image rendering unit generates the light of an image to be superposed and likewise guides said light by means of the at least one optical support element for superposition with the at least one observation beam path. Moreover, in particular for beam shaping and/or beam guidance, at least one diffractive optical coupling element is arranged at the optical support element in the transmission beam path and/or in the reception beam path.

Here, the invention is based on the consideration that, as means of the apparatus for laser ranging, suitable diffractive optical coupling elements are used in conjunction with the transmitting objective, both for decoupling and beam shaping of the strongly astigmatic emission of a semiconductor laser, which may have a laser facet as luminous surface. Moreover, such coupling elements can serve for wavelength selection or beam splitting. The coupling elements are likewise employed to collect the IR laser light, scattered back from a scene, by means of the receiving objective and also to reproduce the display for indicating a distance of an object in the field of vision of a user.

The light transport in the support element is brought about by total internal reflection. In order to excite these light paths by the display or the IR laser, it may be necessary to provide transmission or reflection gratings, which can additionally be used for imaging or beam shaping. In principle, coupling-in and decoupling are functionally independent from one another.

A particular advantage of the invention lies in the solution that can be implemented in a cost-effective way and is based on imaging diffractive structures. This substantially develops a long-range optical instrument in terms of the compactness and performance thereof.

In a preferred configuration of the invention, the at least one diffractive optical coupling element can be embodied as transmission grating or as reflection grating. The light to be coupled-in enters the optical support element by diffraction, in which optical support element it is, in the further course, subjected to total internal reflection up to the decoupling point. In the case of more complex designs, both types of grating may be combined with one another, depending on usage purpose.

Advantageously, the optical support element can be a plane plate preferably formed from glass. The light can be carried forward by total internal reflection between the side faces of the plane plate. The additional diffractive optical coupling elements can, as a matter of routine, be attached well to the glass plate.

In a preferred configuration, the at least one diffractive optical coupling element can be embodied as holographically produced optical element (HOE), for example as sinusoidal grating or hologram. Such coupling elements have a particularly good performance in terms of the coupling efficiency thereof and can be produced more cost-effectively than binary diffraction structures.

Moreover, in a preferred configuration, the optical support element can be arranged 0.5 to 3 mm, particularly preferably 1 to 2 mm, outside of an intermediate image plane. The support element need not be situated in an intermediate image plane because the then additionally required optical power, which increases with distance from the intermediate image plane, can then be caused by the respective imaging diffractive element.

Moreover, the at least one diffractive optical coupling element can advantageously be employed for imaging and beam shaping; by way of example, a cylindrical laser beam can be converted into a circular cross-section. In this case, diffractive optical elements enable solutions which cannot be realized, or can only be realized with great difficulty, using refractive processes, e.g. line-shaped or circular illuminations.

Preferably, at least one diffractive optical coupling element for the transmission beam path can be embodied as circular ring-shaped or open square reflection grating, which is arranged at the optical support element in the region of the optical axis in the observation beam path.

Moreover, the circular ring-shaped optical coupling element can preferably serve as target mark. This structuring would be attractive, in particular because the adjustment of the target mark on the light path of the IR transmission laser in the transmission beam path parallel to the optical axis is dispensed with due to the mutually coupled functionality.

In a preferred configuration of the invention, the optical support element can be embodied as beam splitter with two prisms, between which a diffractive optical coupling element is arranged for coupling-in purposes. Here, a volume hologram, which is introduced in an extended polymer layer, typically with a thickness between 0.1 and 1 mm, between the two prisms, is particularly preferred. The above-described coupling-in renders a balance between the diffraction efficiencies for the light paths in the reception beam path and in the observation beam path necessary, the latter in the zeroth order of diffraction. The balancing is necessary since, firstly, each IR photon, emitted by the semiconductor laser, is required for the laser ranging or each lacking photon reduces the range of the ranging. Secondly, it should be noted that there is the smallest possible impairment of the observation beam path. This balancing is simplified by using a volume hologram. In this case, it is also possible to use two prisms made of the same material.

Alternatively, the diffractive optical coupling element can advantageously be structured in one of the prisms and cemented to the other prism. However, in this case, the optical design of the diffractive optical coupling element is, due to the smaller refractive index difference, under greater strain, for example as a result of more strongly refractive structures, which makes the aforementioned balancing more difficult.

In a preferred embodiment, the optical coupling element can have a whole-area embodiment in the beam splitter. Whole-area coupling-in supports the required balance between the diffraction efficiencies for the light paths in the reception beam path and in the observation beam path, since a possible reduction in the transmission is not noticed by the user due to a lack of pronounced contrast differences.

Moreover, in a preferred configuration of the invention, the at least one reception apparatus can have an avalanche photodiode. Such photodiodes are particularly suitable for detecting very small light intensities, down to individual photons.

Advantageously, the optical coupling element in the beam splitter can contain an imaging function, which brings about focusing of the deflected laser light onto the avalanche photodiode.

In a preferred configuration, the long-range optical instrument can be embodied as binocular field glasses with two observation beam paths. The entire measurement apparatus for laser ranging, comprising transmitter, receiver and display, or else only a part thereof, may be installed in each of the observation beam paths.

Alternatively, the long-range optical instrument can be embodied as telescopic sight with one observation beam path. In this case, the entire measurement apparatus for laser ranging is housed in conjunction with the only available observation beam path.

Further advantageous developments and configurations of the invention emerge from the exemplary embodiments, described in principle in the following text on the basis of the drawings.

In detail:

FIG. 1 shows a schematic beam path in one channel of the long-range optical instrument;

FIG. 2 schematically shows the light decoupling;

FIG. 2a shows a front view of the associated optical support element for FIG. 2;

FIG. 3 schematically shows the coupling-in of laser light;

FIG. 3a shows a front view of the associated optical support element for FIG. 3;

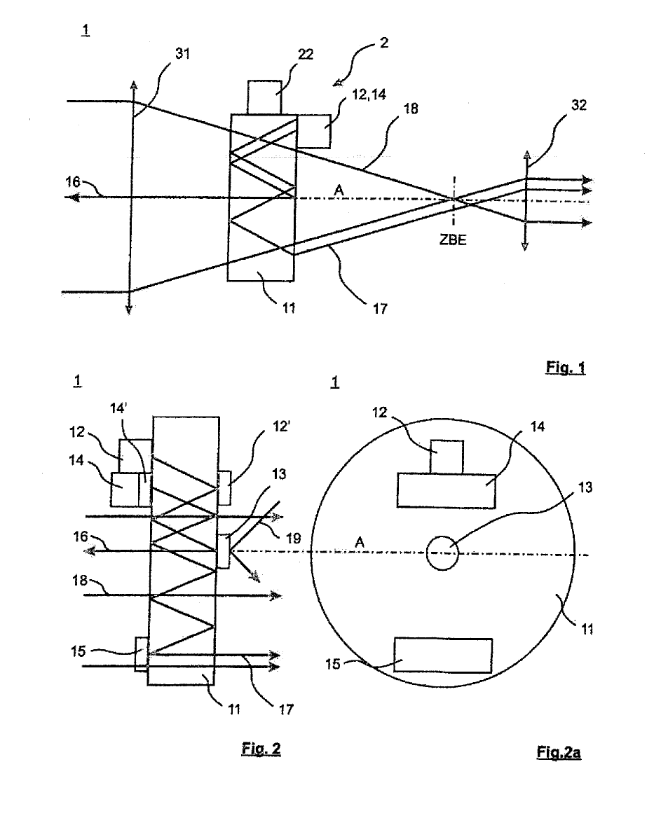

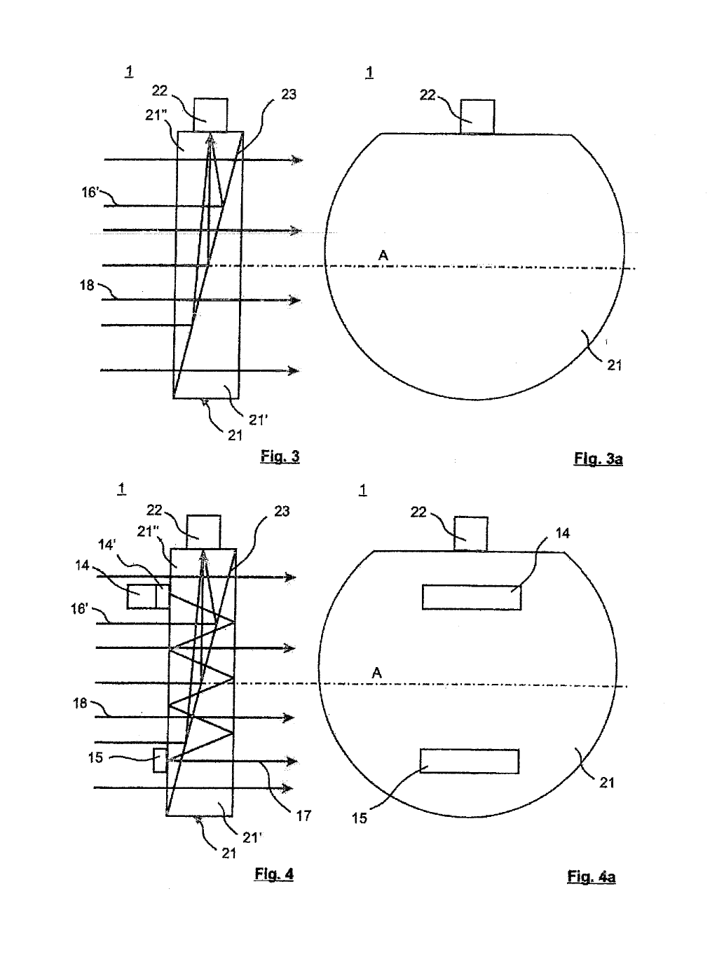

FIG. 4 schematically shows the coupling-in of laser light in combination with an image rendering unit;

FIG. 4a shows a front view of the associated optical support element for FIG. 4;

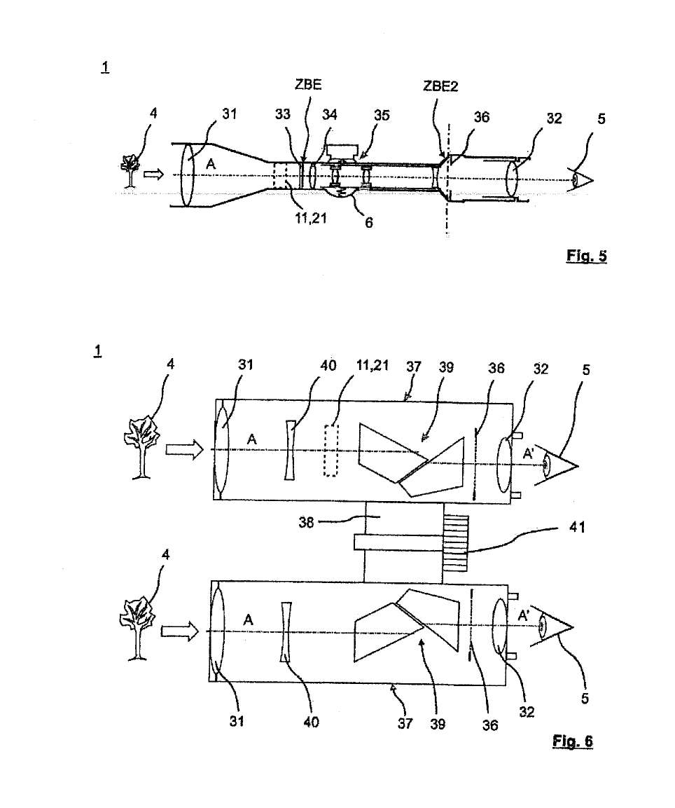

FIG. 5 schematically shows a telescopic sight as long-range optical instrument; and

FIG. 6 schematically shows binocular field glasses as long-range optical instrument.

FIG. 1 schematically shows the path of all relevant beams in one channel of the long-range optical instrument 1. A double telescope has two such channels; a telescopic sight merely has one channel. The means for laser ranging 2 are arranged outside of an intermediate image plane. The coupling elements (not depicted in any more detail in FIG. 1) for the transmission beam path 16 and the image rendering beam path 17 can be embodied as imaging diffractive optical coupling elements. On the optical support element 11, there is, on one side, an IR laser as transmission apparatus 12 and an image rendering unit 14 and, on another side, an avalanche photodiode as reception apparatus 22. The optical support element 11 is configured as a plane-parallel glass plate. The objective 31 images an object at infinity in the intermediate image plane ZBE, in which it is observed by the user by means of the eyepiece 32. The objective 31 may contain a focusing device, which images, in focus, an object at a finite object distance in the intermediate image plane ZBE and, simultaneously, focuses the transmission beam path at the object distance. For reasons of clarity, respectively only one individual ray is depicted, as representative for the IR transmission beam path 16 and the image rendering beam path 17, from those beams which are decoupled from the instrument. The rays that are coupled into the instrument and reach the avalanche photodiode 22 have not been depicted. The optical axis of the decoupled laser extends parallel to the optical axis A of the observation beam path 18. In this figure, and in the subsequent figures, the beam paths are to be understood schematically and may be exemplary.

FIG. 2 shows the light decoupling in the case of long-distance optical instrument 1 and, in FIG. 2a, the front view of the associated optical support element 11 for FIG. 2. Situated on the optical support element 11, which is embodied as glass plate, there is the laser for ranging as transmission apparatus 12 and the display for indicating the distance as image rendering unit 14. If the glass plate is not situated in the intermediate image plane ZBE, a transmission grating 14′, as diffractive optical coupling element, can be arranged upstream of the image rendering unit 14. This renders it possible to generate an image which, together with the eyepiece following to the right-hand side (not depicted in FIG. 2), images the display of the image rendering unit 14 at infinity. The reflection grating as decoupling element 15 for the image rendering beam path can further support this imaging. All diffractive coupling elements, with the exception of the transmission grating 14′, are drawn as reflection gratings here and in the following images. When adapting the beam profile, the same function can also be achieved by means of transmission gratings. The decision as to whether an opaque reflection grating or a transparent transmission grating is used is made by the application.

The light path in the transmission beam path 16 for the IR transmission laser 12 works completely analogously to the just described image rendering beam path, except for that the luminous laser facet is imaged at infinity by the objective 31. The conventionally employed laser diodes have a pronounced elliptical beam profile with very different divergence angles in mutually perpendicular directions. This (double) astigmatism can also be reduced, or even removed, by a suitable design of the reflection grating as coupling element 12′ and of the reflection grating as decoupling element 13 for the transmission beam path 16 downstream of the IR transmission laser 12. Moreover, this renders it possible to generate the required additional optical power in the case where the optical support element 11 is not situated in the intermediate image plane. For the mentioned astigmatism correction, a reflection grating, as depicted, is to be preferred over a transmission grating, since the greater distance from the light source simplifies the correction.

In order to achieve the reflection effect, the reflection gratings 12′ and 13, as coupling elements, are preferably coated by chromium or another metal, which can then act as a mirror in two directions. The sketched reflection grating as decoupling element 13 for the transmission beam path 16 therefore has an additional advantageous property. Provided that, in the case of e.g. a telescopic sight, the laser is adjusted relative to the glass plate in such a way that the optical axis of the decoupled laser is situated parallel to the optical axis of the sighting optical unit, the reflection grating 13 constitutes a target marker, which can also be depicted in an illuminated manner by simple measures. This is intended to be indicated schematically by the illumination beam path 19, which could be realized from the rear side by oblique illumination by a light-emitting diode (not depicted in FIG. 2).

If the efficiency of the decoupling of the laser is of secondary importance, the target marker formed by the reflection grating 13 can also be structured, for example in the shape of a circular ring or an open square.

FIG. 3 schematically shows the coupling of laser light into a long-range optical instrument 1 and, in FIG. 3a, the front view of the associated optical support element 21 for FIG. 3. The optical support element 21 is designed like a beam splitter, which consists of a first prism 21′ with a low refractive index and a second prism 21″ with a high refractive index. An optical coupling element 23 (imagined over the whole area here), which deflects the incident IR photons in the reception beam path 16′ at a suitable angle, is situated between the prisms 21′, 21″ in the beam splitter. Moreover, this diffractive optical coupling element 23 contains an imaging function, which leads to the focusing of the deflected IR light on the avalanche photodiode 22. This procedure increases the efficiency of the detection. It is furthermore advantageous in the case of this arrangement that the avalanche photodiode 22 preferably or only registers IR photons diffracted at the grating, without being impaired by interfering photons from the visible spectral range, since the latter are deflected according to the law of refraction and are not focused either and therefore miss the avalanche photodiode 22.

The lack of an otherwise conventional dichroic beam splitter layer, which would be evaporated onto the side faces of one of the prisms 21′, 21″, is furthermore advantageous. This beam splitter would be polarization sensitive due to the angle of incidence thereof deviating from zero degrees, which would make the design thereof substantially more difficult and therefore would lead to a complicated and expensive coating. Additionally, the grating can be designed in such a way that there is no undesirable reduction in transmission or discoloring for the observation beam path 18, which would only be possible to a restricted extent by means of a dichroic beam splitter.

The beam path in FIG. 3 schematically shows the particularly preferred case, mentioned above, in which the prisms 21′ and 21″ consist of the same material. In this case, the diffractive coupling element is to be imagined as volume hologram in an extended polymer layer (not depicted in any more detail in FIG. 3), which polymer layer simultaneously acts as optical cement. As was already mentioned previously, this functionality can also be achieved with different prism materials, as long as certain disadvantages are accepted.

FIG. 4 schematically shows the coupling-in of laser light in combination with an image rendering unit in a long-distance optical instrument 1 and, in FIG. 4a, the front view of the associated optical support element 21 for FIG. 4. Here, the optical support element 21 is once again designed like a beam splitter, which consists of a first prism 21′ with a low refractive index and a second prism 21″ with a high refractive index. Between the prisms 21′, 21″ in the beam splitter, there once again is an optical coupling element 23, which deflects the incident IR photons in the reception beam path 16′ at a suitable angle in the direction of the avalanche photodiode 22. Consequently, analogously to the circumstances in FIG. 3, the arrangement in FIG. 4 and FIG. 4a is now complemented by a display for indicating the distance as an image rendering unit 14. If the optical support element 21 is not situated in the intermediate image plane, a transmission grating 14′ as diffractive optical coupling element is arranged upstream of the image rendering unit 14 for imaging purposes. The reflection grating as decoupling element 15 for the image rendering beam path 17 can in turn further support this imaging. FIG. 4 contains all options which were already discussed in FIGS. 2 and 3 and is conceived for explaining that the principles of decoupling (FIG. 2) and coupling-in (FIG. 3) can be combined by means of a more complex support plate.

FIG. 5 schematically shows a telescopic sight as long-range optical instrument 1. It comprises a tube, which has piecewise different diameters, and contains an optical system. The optical system consists at least of the objective 31, depicted in FIG. 5, a lens-erecting system with zoom members 35, a field lens 34, a reticle 33 and an eyepiece 32. The objective 31 is situated in a front, usually thickened, region. The objective 31 can also be built from a plurality of individual lenses or cemented members (not depicted in detail in FIG. 5). The objective 31 generates a real image, which is upside down relative to the observance object 4, in a first image plane, the intermediate image plane ZBE, conjugate to the object 4. In the present exemplary embodiment, the reticle 33 is arranged in the region of the intermediate image plane ZBE. The lens-erecting system with zoom members 35 as adjustable optical elements is situated in a central region, which is often referred to as center tube. At least one external adjustment tower 6, by means of which the optical properties of the optical system, or a target line defined by the reticle 33, can be adjusted, can also be situated there. The lens-erecting system erects the upside-down image and images the latter in a new image plane, the second image plane, with a certain linear magnification. In a further exemplary embodiment (not depicted here), the reticle 33 can also be arranged in the region of a second image plane or intermediate image plane ZBE2. If the lens-erecting system contains at least two axially displaceable zoom members 35, these also satisfy the object of making the overall magnification of the image, perceived by the user, continuously selectable in a mechanically restricted region. The eyepiece 32 is arranged in a rear, usually thickened, region. For the purposes of focusing an object 4 observed through the telescopic sight, or for an adaptation to the defective vision of the user, the eyepiece 32 can be displaced axially.

In the region of the first image plane ZBE, the optical support element 11, 21, indicated by a dashed line, can be arranged with further apparatuses for laser ranging with the transmission apparatuses and the reception/rendering apparatuses (not depicted in detail in FIG. 5 for reasons of clarity).

The eyepiece 32 images the image of the second image plane at any distance or serves to focus on the reticle 33. Depending on the magnification setting, a visual field stop 36, near the second image plane ZBE2, restricts the subjectively perceived visual field. A telescopic sight can moreover contain further optical components, (not depicted in FIG. 5) such as e.g. a reticle illumination, a beam coupling-in or decoupling means for ranging or apparatuses for photographic recordings. There can likewise be electronic components, sensors, operating elements or energy storage units, which are required for the aforementioned purposes.

In FIGS. 5 and 6, functionally equivalent elements have been provided with the same reference signs.

FIG. 6 schematically shows binocular field glasses as long-distance optical instrument 1, which have two tubes 37 arranged parallel to one another, which each contain an optical system. In the present case, the tubes 37 are connected to one another by means of at least one two-part bridge 38 with a central axis. Alternatively, they can be fixedly arranged with respect to one another in a common housing (not shown). The eye spacing of a user can be taken into account by an appropriate fold in the case where the at least one two-part bridge 38 is present. In the case of a common housing, the eye spacing of the user can be set by means of e.g. rhombic prisms. The optical system consists of at least one objective 31, a prism system 39, a visual field stop 36 and an eyepiece 32. The objective 31 and the eyepiece each set one optical axis A, A′ (see FIG. 5). The objective 31 can consist of a plurality of individual lenses or cemented members. In order to focus an object 4 observed through the binocular field glasses, it is possible to axially displace either the eyepiece 32 or the whole objective 31. It is likewise possible to displace a lens group, which is generally arranged between the objective 31 and the prism system 39 and which is referred to as focusing lens 40. For focusing purposes, a rotary knob 41 can be arranged on the central axis, by means of which rotary knob the focusing lenses 40 can together be displaced axially. In the region between the focusing lens 40 and the prism system 39, the optical support element 11, 21 is arranged at least in one of the two tubes 37 with the further apparatuses for laser ranging with the transmission apparatuses and the reception/rendering apparatuses (likewise not depicted in detail in FIG. 6 for reasons of clarity).

The objective 31 generates a real image, upside down relative to the observed object 4, in an image plane assigned to the objective 31. For image-erecting purposes, the prism system 39 can be built according to an Abbe-König, Schmidt-Pechan, Uppendahl, Porro prism system, or another prism system variant. The prism system 39 re-erects the upside-down image and images it in an intermediate image plane. A visual field stop 36, which abruptly delimits the visual field, is situated in the intermediate image plane.

The eyepiece 32 serves to image the image of the intermediate image plane at any distance, for example at infinity or at an apparent distance of one meter. A beam direction indicated by the arrow in FIG. 6 is defined by the sequence: object 4-objective 31-prism system 39-eyepiece 32-eye 5. The visual field stop 36 can either be formed by a holder of an optical element or else be defined by a separate stop. It can be imaged in a plane by means of the remaining optical system downstream thereof in the beam direction, which plane lies downstream of the eyepiece 32 in the beam direction and typically has a distance therefrom of between 5 and 25 mm.

Moreover, binocular field glasses can contain further optical components, which, for example, serve for image stabilization, beam coupling-in or decoupling or photographic purposes. There can likewise be electronic components, operating elements or energy storage units, which are required for the aforementioned purposes. Holding devices, on which e.g. a belt for wearing may be fastened, can be situated, usually laterally, on binocular field glasses.

### LIST OF REFERENCE SIGNS

1 Long-range optical instrument
2 Apparatus for laser ranging
4 Object
5 Eye
6 Adjustment tower
11 Optical support element, glass plate
12 Transmission apparatus, IR transmission laser
12′ Reflection grating as coupling element
13 Decoupling element for the transmission beam path, reflection grating
14 Image rendering unit
14′ Transmission grating as coupling element
15 Decoupling element for the image rendering beam path, reflection grating
16 Transmission beam path
16′ Reception beam path
17 Image rendering beam path
18 Observation beam path
19 Light path in the illumination beam path
21 Optical support element made of two prisms
21′ First prism
21″ Second prism
22 Reception apparatus, avalanche photodiode
23 Optical coupling element in the beam splitter
31 Objective
32 Eyepiece
33 Reticle
34 Field lens
35 Zoom members
36 Visual field stop
37 Tube
38 Bridge
39 Prism system
40 Focusing lens
41 Rotary knob
A, A′ Optical axes
ZBE Intermediate image plane, first image plane
ZBE2 Second image plane

1-16. (canceled)

17. A long-range optical instrument, comprising:
at least one observation beam path;
a laser apparatus for laser ranging including at least one transmission apparatus with a transmission beam path and at least one reception apparatus with a reception beam path;
at least one optical support element, wherein at least one of: the transmission beam path of the transmission apparatus or the reception beam path of the reception apparatus are combined using the at least one optical support element for superposition with the at least one observation beam path,
an image rendering unit, wherein the image rendering unit generates light of an image to be superposed and guides said light using the at least one optical support element for superposition with the at least one observation beam path; and
at least one diffractive optical coupling element arranged at the at least one optical support element in at least one of: the transmission beam path or the reception beam path.

18. The long-range optical instrument according to claim 17, wherein the at least one diffractive optical coupling element is embodied as transmission grating or as reflection grating.

19. The long-range optical instrument according to claim 17, wherein the at least one optical support element is a plane plate.

20. The long-range optical instrument according to claim 19, wherein the plane plate is made of glass.

21. The long-range optical instrument according to claim 17, wherein the at least one diffractive optical coupling element is embodied as a holographically produced optical element.

22. The long-range optical instrument according to claim 17, wherein the at least one optical support element is arranged 0.5 to 3 mm outside of an intermediate image plane.

23. The long-range optical instrument according to claim 17, wherein the at least one diffractive optical coupling element is employed for at least one of: imaging, beam shaping or beam guidance.

24. The long-range optical instrument according to claim 17, wherein the at least one diffractive optical coupling element for the transmission beam path is embodied as circular ring-shaped, which is arranged at the at least one optical support element in the region of an optical axis in the beam path.

25. The long-range optical instrument according to claim 24, wherein the circular ring-shaped optical coupling element serves as a target mark.

26. The long-range optical instrument according to claim 17, wherein the at least one diffractive optical coupling element for the transmission beam path is embodied as an open square reflection grating, which is arranged at the at least one optical support element in the region of an optical axis in the beam path.

27. The long-range optical instrument according to claim 17, wherein the at least one optical support element is embodied as beam splitter with two prisms, between which the at least one diffractive optical coupling element is arranged for coupling-in purposes.

28. The long-range optical instrument according to claim 27, wherein the at least one diffractive optical coupling element is a volume hologram, which is introduced in an extended polymer layer between the two prisms.

29. The long-range optical instrument according to claim 27, wherein the at least one diffractive optical coupling element is structured in one of the two prisms and cemented to the other of the two prisms.

30. The long-range optical instrument according to claim 27, wherein the at least one diffractive optical coupling element has a whole-area embodiment in the beam splitter.

31. The long-range optical instrument according to claim 17, wherein the at least one reception apparatus has an avalanche photodiode.

32. The long-range optical instrument according to claim 31, wherein the at least one diffractive optical coupling element in the beam splitter contains an imaging function, which brings about focusing of deflected laser light onto the avalanche photodiode.

33. The long-range optical instrument according to claim 17, wherein the long-range optical instrument is embodied as binocular field glasses with two observation beam paths.

34. The long-range optical instrument according to claim 17, wherein the long-range optical instrument is embodied as telescopic sight with one observation beam path.
